(19) United States
(12) Patent Application Publication
(10) Pub. No.: US 2024/0262407 A1
(43) Pub. Date: Aug. 8, 2024

(54) Foldable Pull Rod Box

(71) Applicant: Ningbo Jiangyong Plastic Industrial Tech Co., Ltd., Ningbo (CN)

(72) Inventor: Lingchen Yu, Ningbo (CN)

(21) Appl. No.: 18/164,647

(22) Filed: Feb. 6, 2023

(51) Int. Cl. B62B 3/02

(52) U.S. Cl. CPC B62B 3/025

(57) ABSTRACT

Provided is a foldable pull rod box, including two panels, bottoms of which are provided with roller wheels. One of the panels is provided with a retractable pull rod. Side plate assemblies are hinged between two ends of the two panels. The side plate assembly includes two side plates hinged with each other. The bottom of one of the panels is hinged with a bottom plate, and an inner wall of the side plates and/or the other panel is provided with a support portion. When the side plate assemblies unfold to a flat state and the bottom plate unfolds to a horizontal state, a containing cavity with an open upper end is formed between the side plate assemblies and the panels. One of the panels is provided with a buckle. The advantages of the disclosure are enjoying compact structure, convenient operation and good use effect, which is convenient to carry.

### TECHNICAL FIELD

The disclosure relates to a pull rod box, in particular to a foldable pull rod box.

### BACKGROUND ART

A shopping cart is a tool that people often use when they go shopping. Especially when carrying some heavy items, the shopping cart brings great convenience to people. Nowadays, people use various shopping devices, including shopping carts, to go shopping. However, most of the shopping carts on the market are simple and are not foldable, and thus, are inconvenient to carry and only suitable to be taken directly to the supermarket or farmers' market. People who go to work or school or go on an errand will give up using the existing shopping cart because it is not convenient to carry.

### SUMMARY OF THE INVENTION

### (1) Technical Problem to be Solved

The technical problem to be solved by the disclosure is to provide a foldable pull rod box that has high structural strength and small volume after folding and is capable of fast folding and convenient to carry.

### (2) Technical Solution to the Problem

The disclosure provides a foldable pull rod box, including two panels arranged in parallel. Bottoms of the panels are provided with roller wheels 9. One of the panels is provided with a retractable pull rod 6. Side plate assemblies capable of bending inward are hinged between two ends of the two panels. The side plate assembly includes two side plates hinged with each other. The bottom of one of the panels is hinged with a bottom plate 4, and an inner wall of the side plates and/or the other panel is provided with a support portion for contacting the bottom plate 4 and supporting the bottom plate. When the side plate assemblies unfold to a flat state and the bottom plate 4 unfolds to a horizontal state and contacts the support portion, a containing cavity with an open upper end is formed between the side plate assemblies and the panels. One of the panels is provided with a buckle 6 for fixing the other panel when the foldable pull rod box is folded.

Further, an upper end of the panel and/or the side plate is provided with a hole and forms a hand-held portion.

Further, the foldable pull rod box further includes a cover plate 5 capable of covering the open end of the containing cavity.

Further, a bottom of the cover plate 5 is provided with a hook 51 hangable on the panel or the side plate.

Further, the panels include a front panel 3 and a rear panel 1, and the retractable pull rod 6 is mounted on the back panel 1. Two ends of a side wall of the front panel 3 are provided with a first groove 31, the buckle 6 is hinged in the first groove 31, and two ends of a side wall of the rear panel are provided with a second groove 11 into which the buckle 6 is clamped and fixed when the foldable pull rod box is folded.

Further, an end of the buckle is provided with an elastic bump 61, and the elastic bump 61 enables the buckle to abut against a surface of the panel.

Further, the inner wall of the panel is provided with a storage slot 12, and an open end of the storage slot 12 is hinged with a cover 13.

Further, edges of the panels bend toward one side of the containing cavity and form reinforcing portions, and an accommodating area capable of accommodating the folded side plates is formed between the reinforcing portions and the panels.

Further, the panels and/or the side plates are provided with reinforcing ribs.

Further, the side plate assembly is provided with a latch 23, the latch 23 is in a slide fit with a top of one of the side plates and slides in a direction parallel to a width direction of the side plate, and a top of the other side plate is provided with a clamping portion 211 into which the latch is inserted and with which fixed connection is realized.

### (3) Beneficial Effects

The foldable pull rod box of the disclosure is capable of fast folding and is convenient to operate and carry. The height of the retractable pull rod can be adjusted conveniently and easily according to needs, which provides good user experience. The support portion can function as a support and improve the bearing capacity, thereby improving the stability and reliability in use. With the hand-held portion, the foldable pull rod box is convenient to move. With the buckle, the foldable pull rod box can be quickly fixed after being folded, which avoids loosening and makes the foldable pull rod box convenient to carry. With the latch, the side plate assembly can be locked quickly, which makes the foldable pull rod box easy to operate and improves the overall structural reliability. With the reinforcing ribs, the foldable pull rod box has beautiful and compact appearance, high overall structural strength and long service life. With the storage slot, small items can be conveniently placed therein, which can prevent the small items from being lost. With the hangable cover, the foldable pull rod box can be closed, and the hangable cover can be hung on the panel instead of being placed on the ground, so that the user can put the items into the foldable pull rod box conveniently, which thereby provides good user experience. The foldable pull rod box of the disclosure has the advantages of compact structure, convenient operation and good use effect, and is convenient to carry.

### BRIEF DESCRIPTION OF THE DRAWINGS

FIG. 1 is a schematic structural diagram of a foldable pull rod box of the disclosure;

FIG. 2 is a schematic structural diagram of the foldable pull rod box of the disclosure from another angle;

FIG. 3 is a schematic diagram of the foldable pull rod box of the disclosure when in use;

FIG. 4 is an enlarged view of Part A in FIG. 3;

FIG. 5 is a schematic structural diagram of a storage slot of the foldable pull rod box of the disclosure;

FIG. 6 is a schematic structural diagram of a latch of a level of the foldable pull rod box of the disclosure;

FIG. 7 is an enlarged view of Part B in FIG. 5;

FIG. 8 is a sectional view of the foldable pull rod box of the disclosure;

FIG. 9 is a schematic diagram showing the status of side plates when the foldable pull rod box of the disclosure is to be folded;

FIG. 10 is a schematic diagram showing the status of a bottom plate when the foldable pull rod box of the disclosure is to be folded;

FIG. 11 is an enlarged view of Part C in FIG. 10; and

FIG. 12 is a schematic structural diagram of the foldable pull rod box of the disclosure after being folded.

### DETAILED DESCRIPTION OF THE INVENTION

Embodiments of the disclosure will be introduced in detail in conjunction with the accompanying drawings.

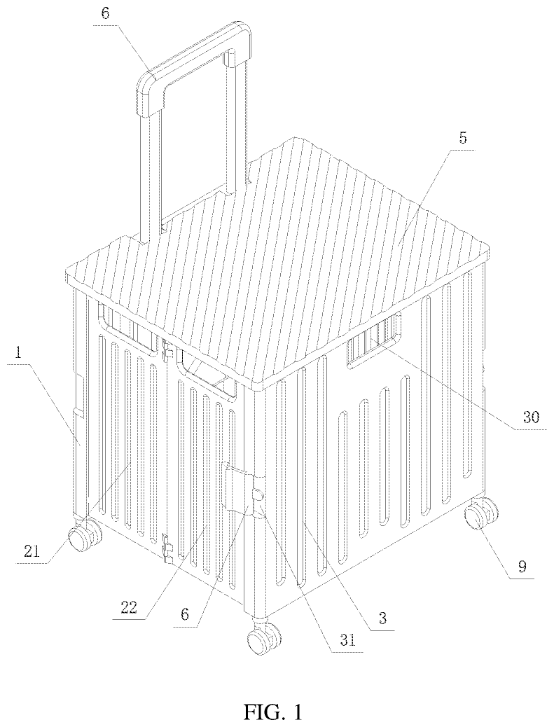

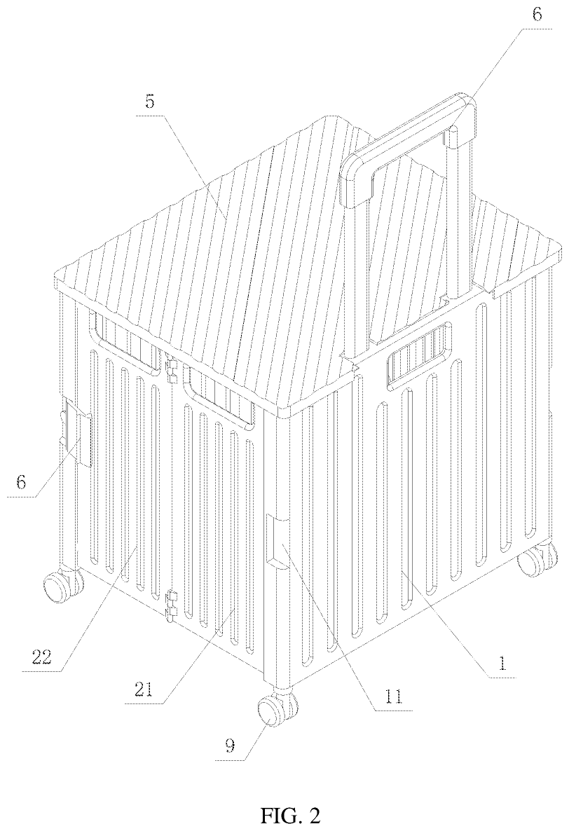

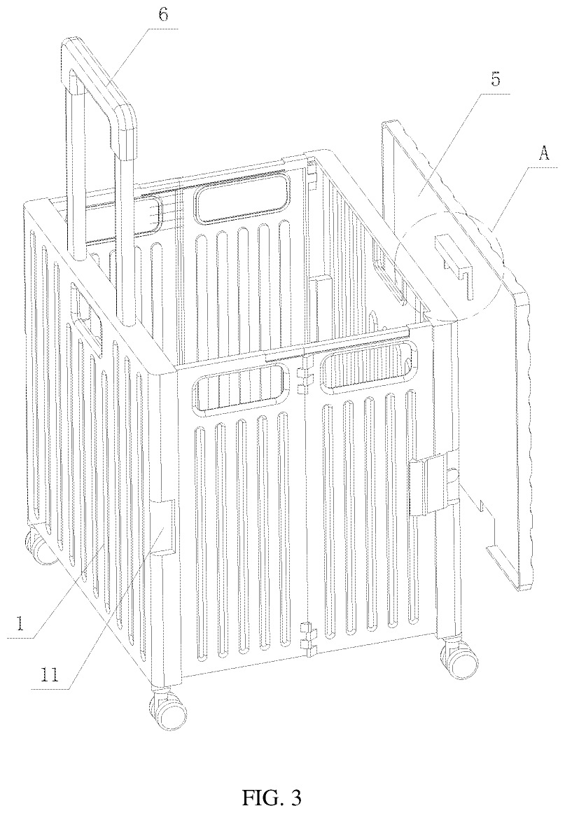

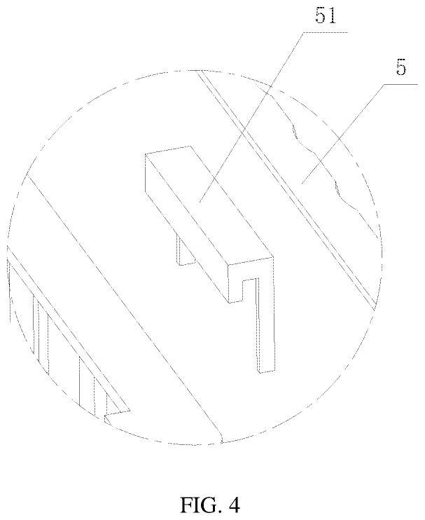

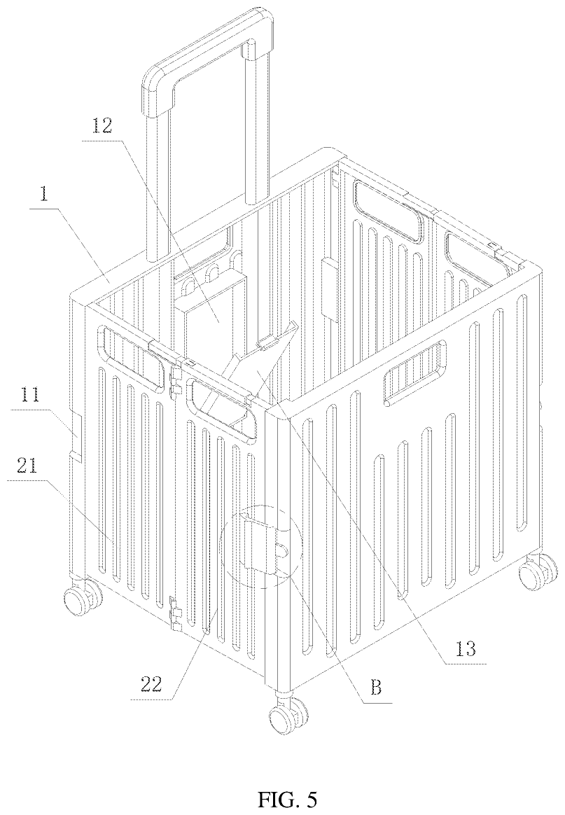

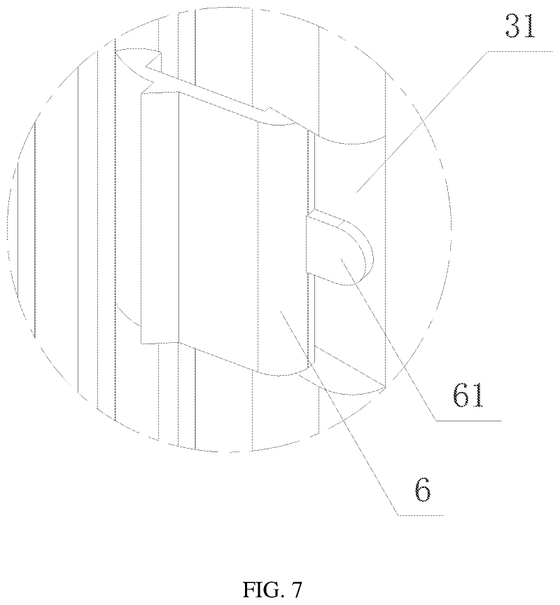

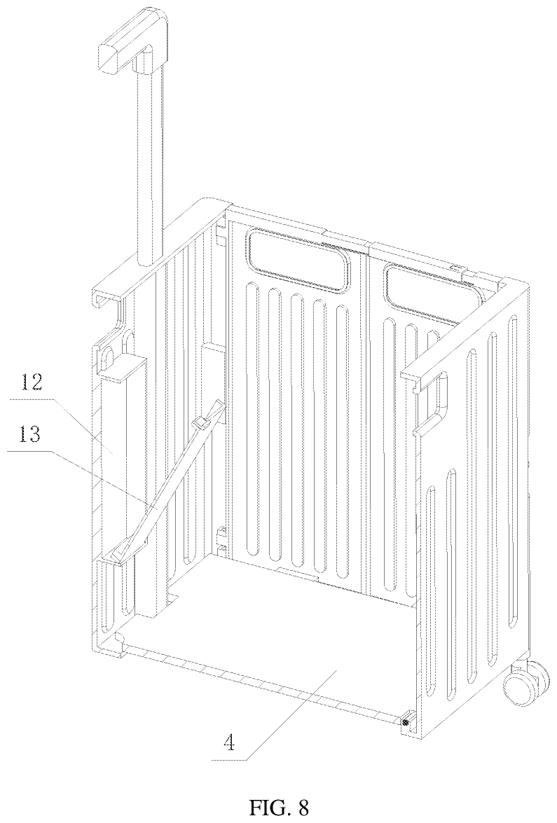

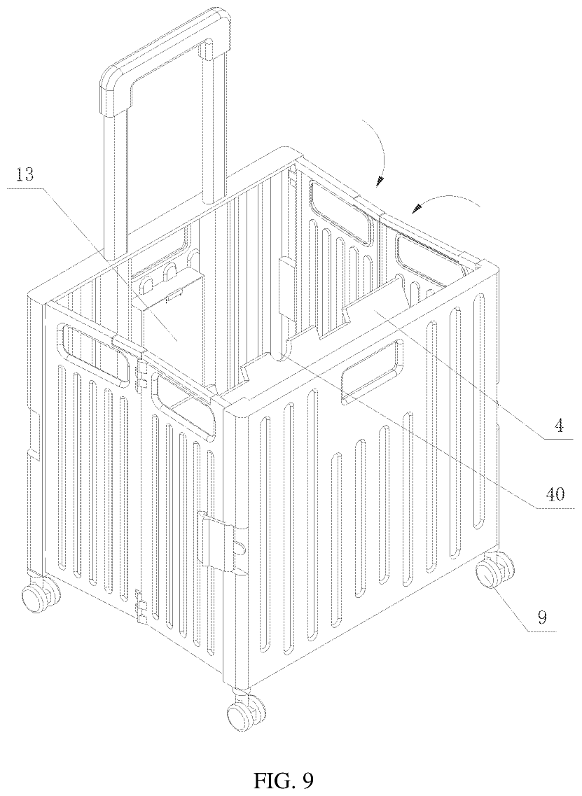

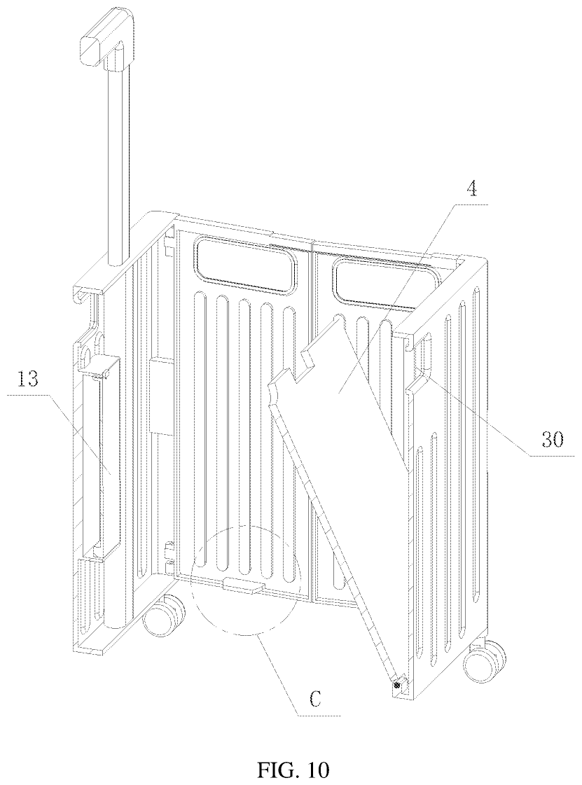

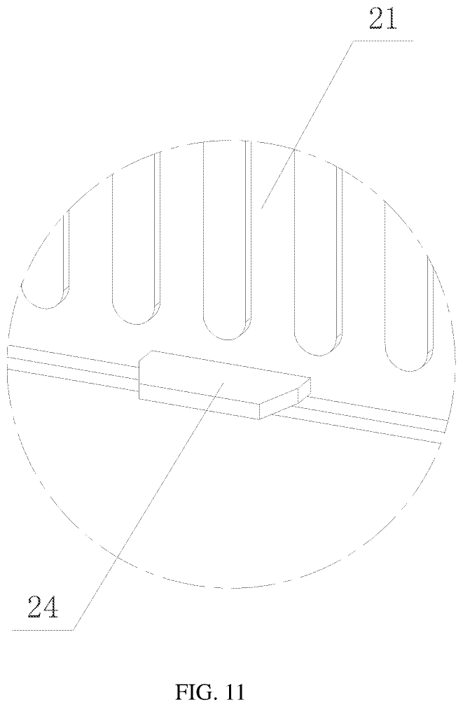

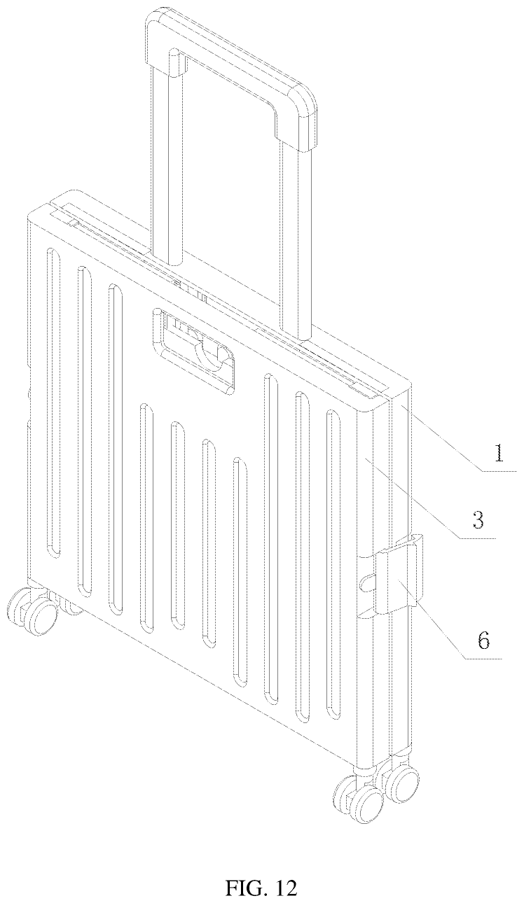

Referring to FIG. 1 to FIG. 12, the disclosure provides a foldable pull rod box, including two panels arranged in parallel. Bottoms of the panels are provided with roller wheels 9. One of the panels is provided with a retractable pull rod 6. Side plate assemblies capable of bending inward are hinged between two ends of the two panels. The side plate assembly includes two side plates hinged with each other. The bottom of one of the panels is hinged with a bottom plate 4, and an inner wall of the side plates and/or the other panel is provided with a support portion for contacting the bottom plate 4 and supporting the bottom plate. When the side plate assemblies unfold to a flat state and the bottom plate 4 unfolds to a horizontal state and contacts the support portion, a containing cavity with an open upper end is formed between the side plate assemblies and the panels. One of the panels is provided with a buckle 6, and the buckle 6 is used for fixing the other panel when the foldable pull rod box is folded.

A detailed description will be made below:

The panels include a front panel 3 and a rear panel 1. The front panel 3 and the rear panel 1 are parallel to each other. Two ends of the front panel and the rear panel are respectively connected with a side plate assembly. The side plate assembly includes a first side plate 21 and a second side plate 22 hinged with each other. The first side plate and the second side plate are both rectangular. An end of the first side plate is hinged with an edge of the rear panel, and an end of the second side plate is hinged with an edge of the front panel. The side plate assembly can bend inward. The rear panel 1 is provided with the retractable pull rod 6. The retractable pull rod can extend and retract to satisfy different heights. Two ends of a bottom surface of the front panel and the rear panel are respectively provided with roller wheels 9, and the roller wheels 9 are casters with brakes. A bottom of the front panel is hinged with the bottom plate 4. The overall bottom plate 4 is a rectangular structure rotatably mounted at a lower end of a side wall of the front panel with its axis of rotation parallel to the horizontal plane. A lower end of a side wall of the side plates is provided with the support portion 24. The support portion 24 is used for contacting the bottom plate that has unfolded to a horizontal state and for supporting the bottom plate. Meanwhile, the side wall of the rear panel is also provided with the support portion.

In order to unfold the bottom plate 4 conveniently, an edge of the bottom plate 4 is provided with a recess 40. When the bottom plate needs to be unfolded, a finger is inserted into the recess and the bottom plate 4 is pulled to rotate, thereby completing the folding.

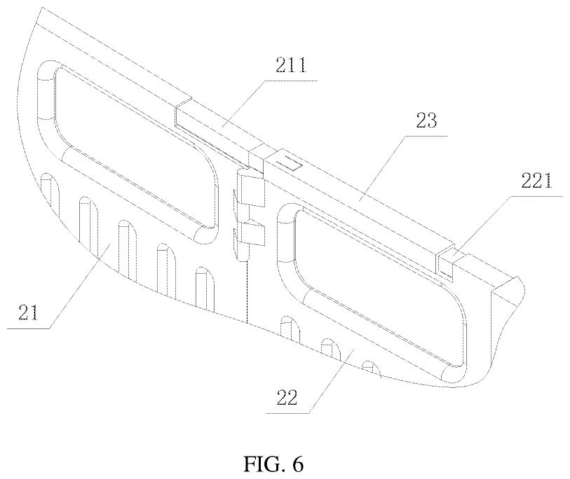

In order to further improve the reliability in use, the side plate assembly is provided with a latch 23. Specifically, referring to FIG. 6, a top of the second side plate is provided with a sliding portion 221. The latch 23 is in a slide fit with the sliding portion and slides in a direction parallel to a width direction of the side plate. A top of the first side plate is also provided with a clamping portion 211 into which the latch 23 can be inserted and with which the first side plate and the second side plate can be fixedly connected, thereby avoiding rotation or shaking, and ensuring the first side plate and the second side plate to be on the same plane.

Two ends of a side wall of the front panel 3 are provided with a first groove 31, the buckle 6 is hinged in the first groove 31, and two ends of a side wall of the rear panel are provided with a second groove 11. When the foldable pull rod box is folded, the buckle 6 can be clamped into the second groove 11, and the front panel and the rear panel can be fixedly connected. In order to prevent the buckle from collision caused by rotation when the foldable pull rod box is unfolded, in this embodiment, an end of the buckle is provided with an elastic bump 61. The elastic bump 61 is in contact with the side wall of the panel and enables the buckle to abut against a surface of the panel, thereby avoiding shaking during use and improving the user experience.

Edges of the front panel and the rear panel bend toward one side of the containing cavity and form reinforcing portions, and an accommodating area capable of accommodating the folded side plates is formed between the reinforcing portions and the panels. After the foldable pull rod box is folded, the reinforcing portions at the side walls of the front panel and the rear panel abut against each other, and the side plates are located inside, so that the foldable pull rod box has compact appearance and beautiful structure.

The inner wall of the panel is provided with a storage slot 12. In this embodiment, the storage slot 12 is arranged at the side wall of the rear panel. The storage slot includes a rectangular ring-shaped protrusion and has an open end facing forward (toward the front panel). The storage slot is formed in the ring-shaped protrusion. An open end of the storage slot 12 is hinged with a cover 13 that can be closed, so that small items can be placed in the storage slot.

An upper end of the panels (the front panel and the rear panel) and the side plates is provided with a hole 30. The hole forms a hand-held portion that can be held by a hand.

The foldable pull rod box of the disclosure further includes a cover plate 5 capable of covering the open end of the containing cavity. An edge of the cover plate 5 bends downward and forms a limiting portion, which can avoid horizontal slip after the cover plate is closed. A bottom of the cover plate 5 is provided with a hook 51. The hook 51 is L-shaped and is integrally formed by injection molding. The cover plate 5 can be hung on the panel or the side plate, specifically on the hole 30 in the panel, by means of the hook. When the user wants to put items into the foldable pull rod box, the cover is hung on the panel instead of being placed on the ground, making the cover plate dirty.

In this embodiment, the panels and the side plates are provided with reinforcing ribs. Specifically, the front panel, the rear panel and the side plates are all formed by injection molding, so that strip-shaped protrusions are provided on the panels and the side plates and form the reinforcing ribs, which can improve the overall structural strength.

The foldable pull rod box of the disclosure is capable of fast folding and is convenient to operate and carry. The height of the retractable pull rod can be adjusted conveniently and easily according to needs, which provides good user experience. The support portion can function as a support and improve the bearing capacity, thereby improving the stability and reliability in use. With the hand-held portion, the foldable pull rod box is convenient to move. With the buckle, the foldable pull rod box can be quickly fixed after being folded, which avoids loosening and makes the foldable pull rod box convenient to carry. With the latch, the side plate assembly can be locked quickly, which makes the foldable pull rod box easy to operate and improves the overall structural reliability. With the reinforcing ribs, the foldable pull rod box has beautiful and compact appearance, high overall structural strength and long service life. With the storage slot, small items can be conveniently placed therein, which can prevent the small items from being lost. With the hangable cover, the foldable pull rod box can be closed, and the hangable cover can be hung on the panel instead of being placed on the ground, so that the user can put the items into the foldable pull rod box conveniently, which thereby provides good user experience. The foldable pull rod box of the disclosure has the advantages of compact structure, convenient operation and good use effect, and is convenient to carry.

The above description is only preferred implementations of the disclosure. It should be noted that those of ordinary skill in the art can also make several improvements and modifications without departing from the technical principles of the disclosure, and such improvements and modifications should also be considered as the protection scope of the disclosure.

What is claimed is:

1. A foldable pull rod box, comprising two panels arranged in parallel, wherein bottoms of the panels are provided with roller wheels, one of the panels is provided with a retractable pull rod, side plate assemblies capable of bending inward are hinged between two ends of the two panels, the side plate assembly comprises two side plates hinged with each other, the bottom of one of the panels is hinged with a bottom plate, and an inner wall of the side plates and/or the other panel is provided with a support portion for contacting the bottom plate and supporting the bottom plate; when the side plate assemblies unfold to a flat state and the bottom plate unfolds to a horizontal state and contacts the support portion, a containing cavity with an open upper end is formed between the side plate assemblies and the panels; and one of the panels is provided with a buckle for fixing the other panel when the foldable pull rod box is folded.

2. The foldable pull rod box according to claim 1, wherein an upper end of the panel and/or the side plate is provided with a hole and forms a hand-held portion.

3. The foldable pull rod box according to claim 1, further comprising a cover plate capable of covering the open end of the containing cavity.

4. The foldable pull rod box according to claim 3, wherein a bottom of the cover plate is provided with a hook hangable on the panel or the side plate.

5. The foldable pull rod box according to claim 1, wherein the panels comprise a front panel and a rear panel, and the retractable pull rod is mounted on the back panel; and two ends of a side wall of the front panel are provided with a first groove, the buckle is hinged in the first groove, and two ends of a side wall of the rear panel are provided with a second groove into which the buckle is clamped and fixed when the foldable pull rod box is folded.

6. The foldable pull rod box according to claim 1, wherein an end of the buckle is provided with an elastic bump, and the elastic bump enables the buckle to abut against a surface of the panel.

7. The foldable pull rod box according to claim 1, wherein the inner wall of the panel is provided with a storage slot, and an open end of the storage slot is hinged with a cover.

8. The foldable pull rod box according to claim 1, wherein edges of the panels bend toward one side of the containing cavity and form reinforcing portions, and an accommodating area capable of accommodating the folded side plates is formed between the reinforcing portions and the panels.

9. The foldable pull rod box according to claim 1, wherein the panels and/or the side plates are provided with reinforcing ribs.

10. The foldable pull rod box according to claim 1, wherein the side plate assembly is provided with a latch, the latch is in a slide fit with a top of one of the side plates and slides in a direction parallel to a width direction of the side plate, and a top of the other side plate is provided with a clamping portion into which the latch is inserted and with which fixed connection is realized.
